(19) United States
(12) Patent Application Publication
(10) Pub. No.: US 2017/0351855 A1
(43) Pub. Date: Dec. 7, 2017

(54) IDENTIFYING SENSITIVE INFORMATION IN A COMMUNICATION BASED ON NETWORK COMMUNICATIONS HISTORY

(71) Applicant: INTERNATIONAL BUSINESS MACHINES CORPORATION, Armonk, NY (US)

(72) Inventors: Corville O. Allen, Morrisville, NC (US); Joseph N. Kozhaya, Morrisville, NC (US); Neil Sahota, Costa Mesa, CA (US)

(21) Appl. No.: 15/172,726

(22) Filed: Jun. 3, 2016

(51) Int. Cl. G06F 21/51; G06F 17/30; G06F 21/60; H04L 29/06

(52) U.S. Cl. CPC G06F 21/51; H04L 63/1408; G06F 17/30958; G06F 21/604; G06F 2221/032

(57) ABSTRACT

A method for identifying sensitive information in a communication may include analyzing a plurality of communications associated with a user in a social networking system for concept and entity sharing to create a relationship graph of concept and entity sharing history. The method may also include analyzing a current communication from the user to extract one or more elements from the current communication. Each element may include an associated concept or entity and an associated sensitivity level. The method may additionally include determining a recipient based sensitivity level for each element based on an identity of each recipient and a relationship or connection of each recipient with each element using the relationship graph. The method may further include providing an indication of sending sensitive information in response to the recipient based sensitivity level of a particular element exceeding a configurable risk level threshold.

### CROSS-REFERENCE TO RELATED APPLICATIONS

The present application is related to U.S. patent application Ser. No. 14/702,200, filed May 1, 2015, entitled “Audience-Based Sensitive Information Handling for Shared Collaborative Documents,” which is assigned to the assignee as the present application and is incorporated herein by reference.

### BACKGROUND

Aspects of the present invention relate to communications networks, social networks, message boards, online mail clients and the like, and more particularly to a method, system and computer program product for identifying sensitive information in a communication based on network communications history.

Transmitting a communication or message containing sensitive information, such a proprietary or confidential information or other information that by its nature is sensitive, to an unintended recipient or to a recipient who is not authorized to have access to such information may result in adverse consequences.

### BRIEF SUMMARY

Aspects of the present invention include a method for identifying sensitive information in a communication and an associated system and computer program product.

According to one embodiment of the present invention, a method for identifying sensitive information in a communication may include analyzing, by a processor, a plurality of communications associated with a user in a social networking system for concept and entity sharing to create a relationship graph of concept and entity sharing history. The method may also include analyzing, by the processor, a current communication from the user to one or more recipients to extract one or more elements from the current communication. Each element may include an associated concept or entity and an associated sensitivity level. The method may additionally include determining, by the processor, a recipient based sensitivity level for each element based on an identity of each recipient and a relationship or connection of each recipient with each element using the relationship graph. The method may further include providing, by the processor, an indication of sending sensitive information to a particular recipient for a particular element in response to the recipient based sensitivity level of the particular element exceeding a configurable risk level threshold.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A-1B (collectively FIG. 1) are a flow chart of an example of a method for identifying sensitive information in a communication in accordance with an embodiment of the present invention.

FIG. 2 is a flow chart of an example of a method for determining a sensitivity level of an element in accordance with an embodiment of the present invention.

FIG. 3 is a flow chart of an example of a method for analyzing a document for confidential information and sensitive information in accordance with an embodiment of the present invention.

FIG. 4 is an example of a relationship graph in accordance with an embodiment of the present invention.

FIG. 5 is an example of determining a recipient based sensitivity level in accordance with an embodiment of the present invention.

FIG. 6 is a block schematic diagram of an example of a social community client in accordance with an embodiment of the present invention.

FIG. 7 is a block schematic diagram of an example of a system for identifying sensitive information in a communication in accordance with an embodiment of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In accordance with an embodiment of the present invention, an outgoing communication by a user may be cross-correlated against social communities to which the user and recipients belong in a social networking system to ensure that sensitive and/or confidential information is not disclosed to unauthorized recipients. Membership in the different communities, analysis of text of other communications and/or documents each member writes or shares, and direct and calculated connections to derive confidentiality of the concepts and entities in the text may be used to determine a sensitivity level of the concepts and entities in the outgoing communication. An alert may be provided to the sender that the outgoing communication is possibly being sent to a wrong or unauthorized recipient. In another embodiment, the sender may be restricted from sending the outgoing communication to the wrong or unauthorized recipient.

In accordance with an embodiment, natural language processing (NLP) and/or other text analytics may be performed on the text of the outgoing communication and compared to information associated with the user sending the communication and the target recipients of the communication. Based on the comparison, potential disclosure of sensitive information or text may be highlighted to the sender or brought to the sender's attention by some alerting mechanism.

In accordance with another embodiment, the invention may include two components. A first component may include building or creating a relationship graph between the user and other users in different social communities in a social networking system or systems. Another component or second component may include tracking communications and identifying sensitive information that is in the process of being communicated to an unauthorized user, wrong user or user that has not previously received the identified sensitive information. Communications or documents previously written or shared with members of a particular community are checked or analyzed for confidentiality and/or sensitivity for individuals or community members with direct connections to the content and the concepts and entities disclosed therein. The sensitivity and confidentiality may be determined by tags, document markings or the content within indicating or expressing restrictions or limitations or use and/or disclosure or distribution.

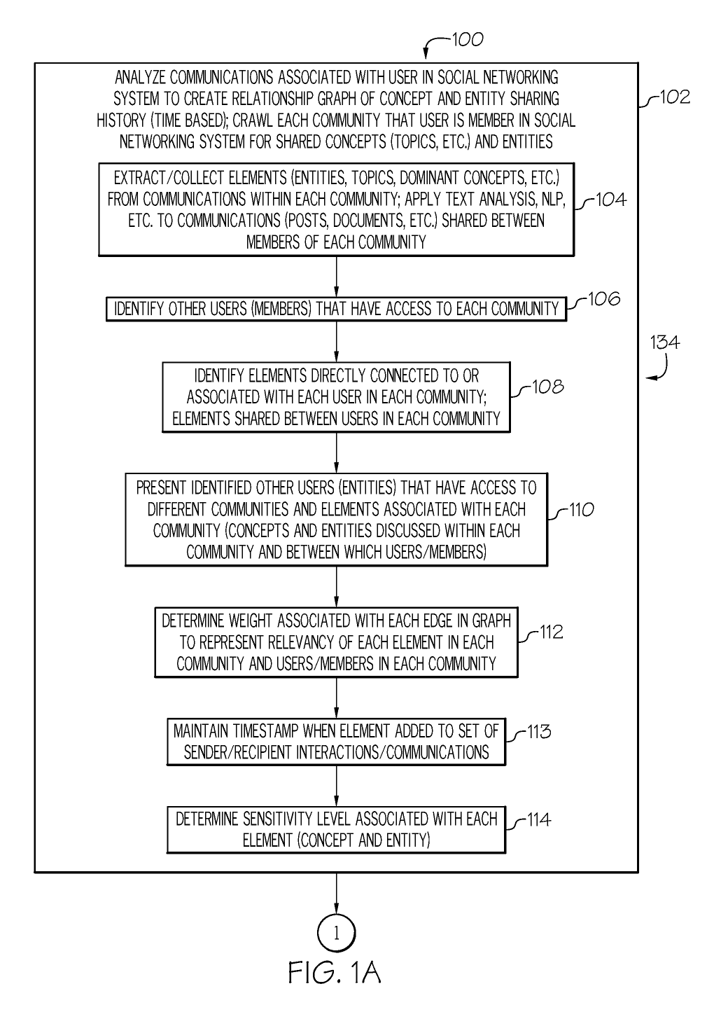

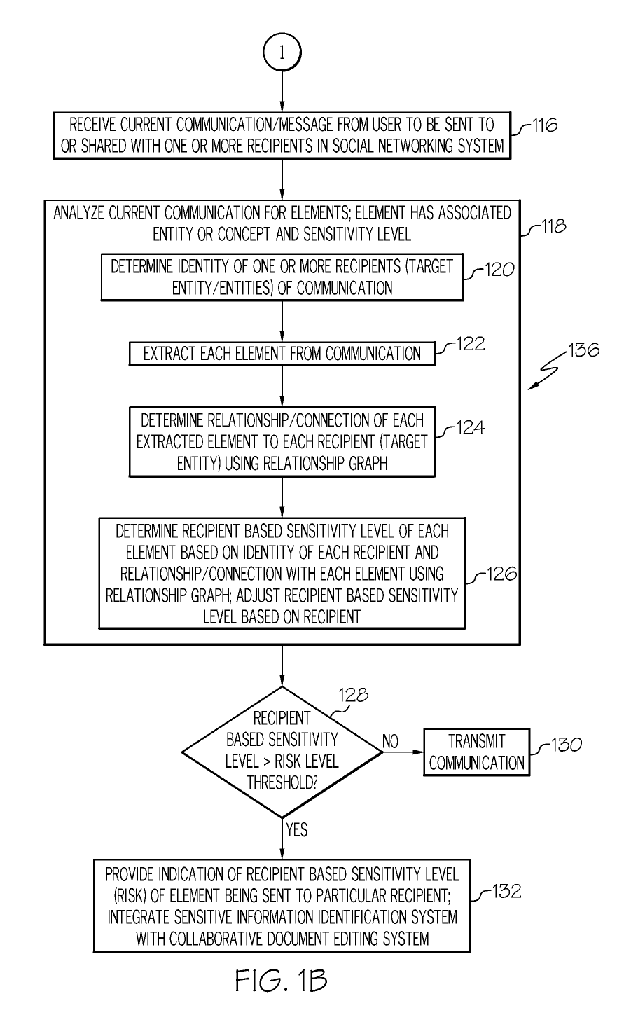

FIGS. 1A-1B (collectively FIG. 1) are a flow chart of an example of a method 100 for identifying sensitive information in a communication in accordance with an embodiment of the present invention. In block 102, a plurality of communications associated with a user in a social networking system may be analyzed for concept and entity sharing to create a relationship graph of concept and entity sharing history. Each communication of the plurality of communication of the user are analyzed to determine a confidentiality and/or sensitivity of each of a plurality of elements (concepts and entities) in the communications associated with the user. The features described with respect to blocks 104-114 may be operations or functions performed as part of block 102.

In block 104, a plurality of elements (concepts and entities) may be extracted and/or collected from communications associated with the user in each community of a plurality of communities to which the user is a member. Natural language processing (NLP) or other text analytics may be applied to the communications shared between the members of each community to extract or collect the elements. Elements may include concepts and entities. Concepts may include but are not necessarily limited to topics or subject matter mentioned or discussed in the shared communications. Entities may include but are not necessarily limited to persons, organizations or other items mentioned or discussed in the shared communications. The shared communications may include but are not necessarily limited to posts, documents, e-mails, text messages, chats or other electronic communications shared between users within a particular online community or social network.

In block 106, other users or members that have access to each community of the plurality of communities may be identified.

In block 108, elements connected to or associated with each user or member in each community may be identified. Elements shared between users in each community may be identified or determined. Concepts and entities may be identified and the relationship or connection of the other users or members in each community to each concept and entity may be determined.

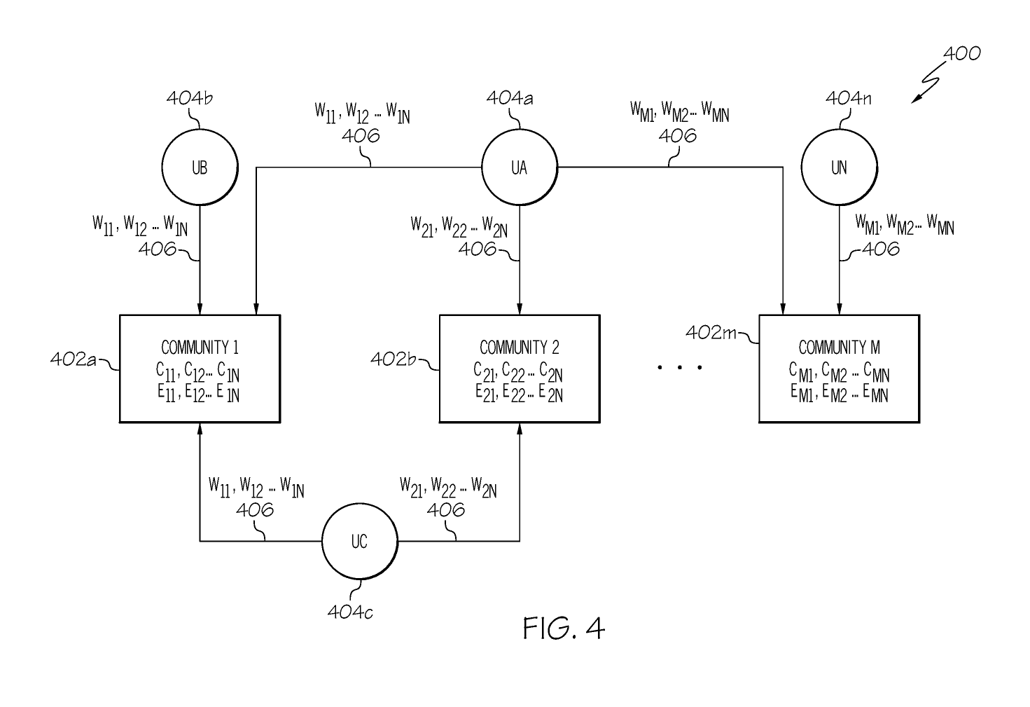

In block 110, other users or members (entities) that have been identified as having access to different communities and elements associated with each community may be presented to the user on a display of a communications device. The communications device may be a computer system or other communications device. The other users or members of each community and elements associated with each community presented define a relationship graph of concept and entity sharing history. Concepts and entities discussed within each community and between which users or members within each community are presented or displayed in the relationship graph of concept and entity sharing history. An example of a relationship graph of concept and entity sharing history will be described with reference to FIG. 4.

In block 112, a weight associated with each edge or connecting link between users and communities in the relationship graph may be determined. The weight may represent a relevancy of each element, concept or entity in each community and associated users or members in each community. A higher weight represents a higher relevance of a particular user or member with respect to a particular element, concept or entity compared to other users or members in the community. A weight associated with a user may be used to determine a recipient based sensitivity level value with respect to a particular element, concept or entity for that user.

In block 113, a timestamp of when an element (concept or entity) was added to a set of sender/recipient interactions may be maintained. A mechanism may be provided that allows users to reset the timestamp if desired. The timestamp associated with a particular element may be updated based on the particular element being identified in a communication or based on some other event. If the timestamp becomes old, outdated or expires after a preset time period or specific date in the future, the element associated with the timestamp may be highlighted or by some other mechanism brought to the attention of the sender. If a particular event is to occur on a certain date and this information is sensitive, an alert may be generated and presented to the sender in response to a communication referring to the event or containing information about the event being sent, prior to the certain date of the event, to an unintended recipient or to a recipient that has not previously received communications about the particular event.

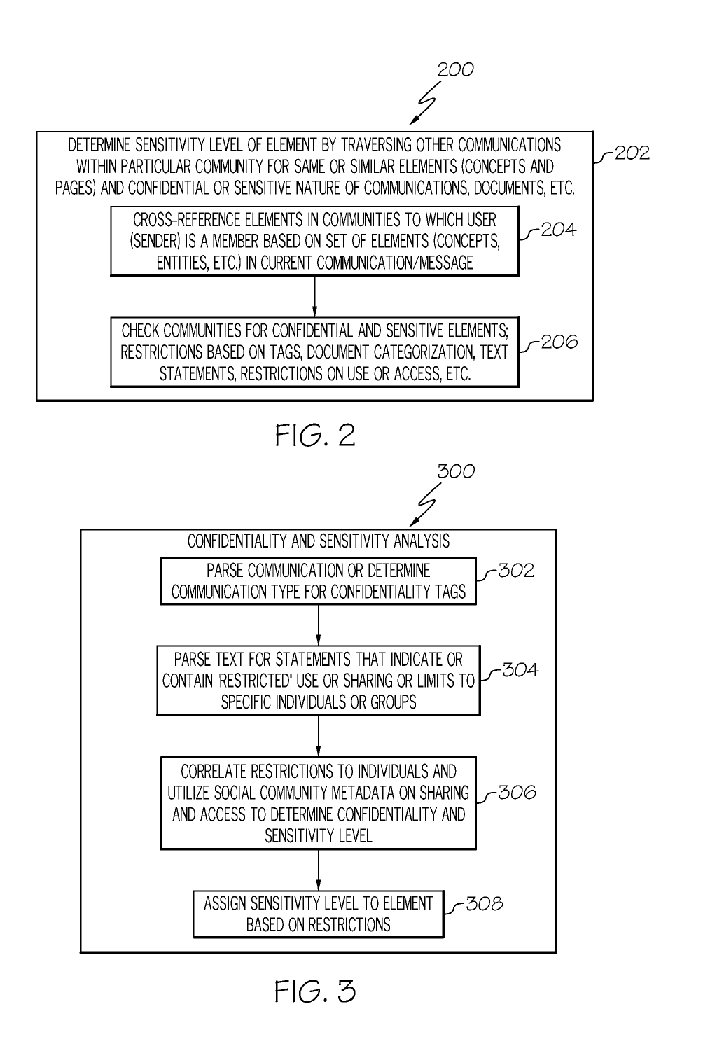

In block 114, a sensitivity level or sensitivity level value associated with each element (concept or entity) may be determined. An example of a method for determining a sensitivity level will be described with reference to FIG. 2. The sensitivity level associated with each concept and entity in the relationship graph may be determined from at least metadata associated with each concept and entity in communications associated with the user in the social networking system.

Determining the sensitivity level associated with each concept and entity may include traversing other communications for the confidential or sensitive nature of each concept and entity. Each concept and entity may be cross-referenced in other communities to which the user is a member to determine the sensitivity level associated with each concept and entity. Each other community to which the user is a member may be checked for the sensitivity level associated with each concept and entity based on tags, document categorization, text statements, restrictions on use or restrictions on access to information associated with each concept and entity.

As an example of determining the sensitivity level of each concept and entity, a higher sensitivity level value may be assigned to a particular concept or particular entity in response to information associated with the particular concept or particular entity being found in one or more documents that are designated or tagged as being confidential and/or other text in the one or more documents indicating that knowledge of or access to the information associated with the particular concept or particular entity is limited. Alternatively, a lower sensitivity level value is assigned to the particular concept or particular entity in response to the information associated with the particular concept or particular entity being publicly available or for some other reason is not considered to be of a sensitive or confidential nature.

In block 116, a current communication or message may be received from the user to be sent to or shared with one or more recipients in the social network system. The current communication or message may be received by a communications device or the user or by a server that is part of the social networking system.

In block 118, the current communication from the user to one or more recipients may be analyzed to extract one or more elements from the current communication. Each element may include an associated concept or entity and an associated sensitivity level. The blocks 120-126 may include operations or functions that may be performed as part of block 118.

In block 120, an identity of one or more recipients of the current communication may be determined. The one or more recipients identified may be referred to as a target entity or target entities.

In block 122, each element, i.e., concept or entity may be extracted from the current communication. Each element may be extracted by performing NLP and/or other text analytics on the current communication.

In block 124, a relationship and/or connection of each recipient to each extracted element may be determined using the relationship graph of concept and entity sharing history.

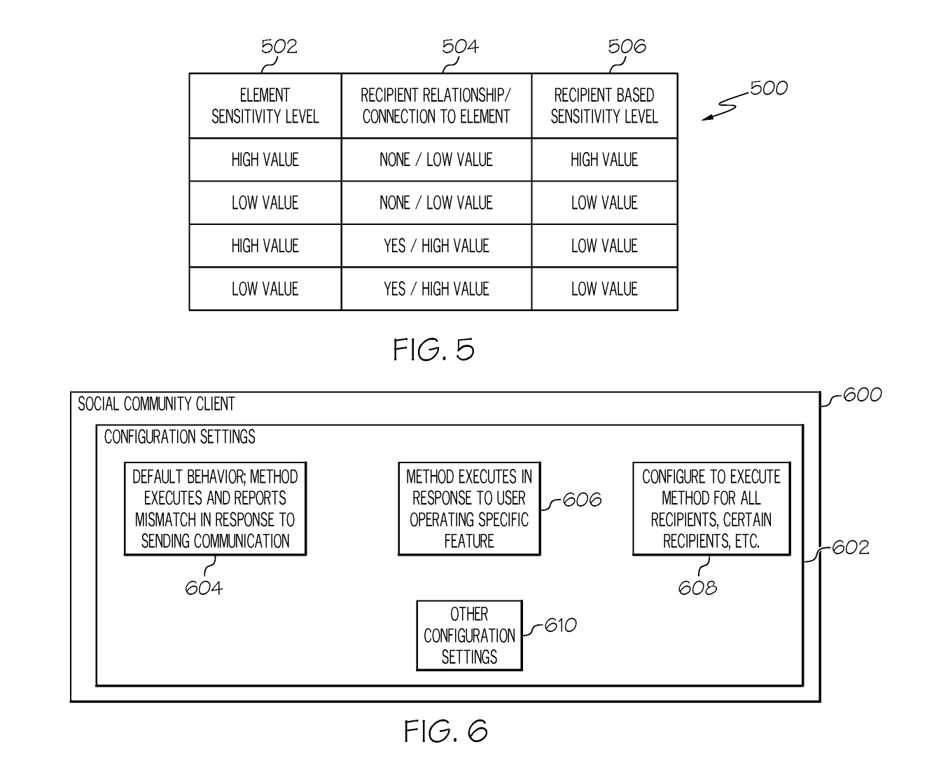

In block 126, a recipient based sensitivity level for each element based on an identity of each recipient and a relationship or connection of each recipient with each element is determined using the relationship graph. The recipient based sensitivity level may be adjusted based on the identity of the recipient and the relationship or connection of the recipient to the element in the relationship graph. Weights of edges of the relationship graph as determined in block 112 and shown in FIG. 4 corresponding to the relevance of each user or recipient with respect to a particular element (concept C or entity E in FIG. 4) may be used to adjust the recipient based sensitivity level as a function of the weight and sensitivity level value of the particular element. An example of determining a recipient based sensitivity level for a particular element will be described with reference to FIG. 5.

In block 128, a determination may be made whether the recipient based sensitivity level exceeds a configurable risk level threshold. The risk level threshold may be configured or set by the user or by an organization to a higher or lower threshold value depending upon how risk averse the user or organization may be in sending sensitive information to an unintended or wrong recipient or to a recipient that the user or organization does not want to have access or knowledge of information associated with a particular element, concept or entity.

If the recipient based sensitivity level does not exceed the configurable risk level threshold value in block 128, the method 100 may advance to block 130. In block 130, the current communication may be transmitted or shared with the recipient.

If the recipient based sensitivity level does exceed the configurable risk level threshold in block 128, the method 100 may advance to block 132. In block 132, an alert or indication of sending sensitive information to a particular recipient for a particular element may be provided or presented to the user, prior to transmitting or sharing the communication, in response to the recipient being unauthorized or an unintended recipient. In accordance with an embodiment, a live collaborative document editing system and the social networking system may be integrated for live contextual feedback for redaction options, views and configuration.

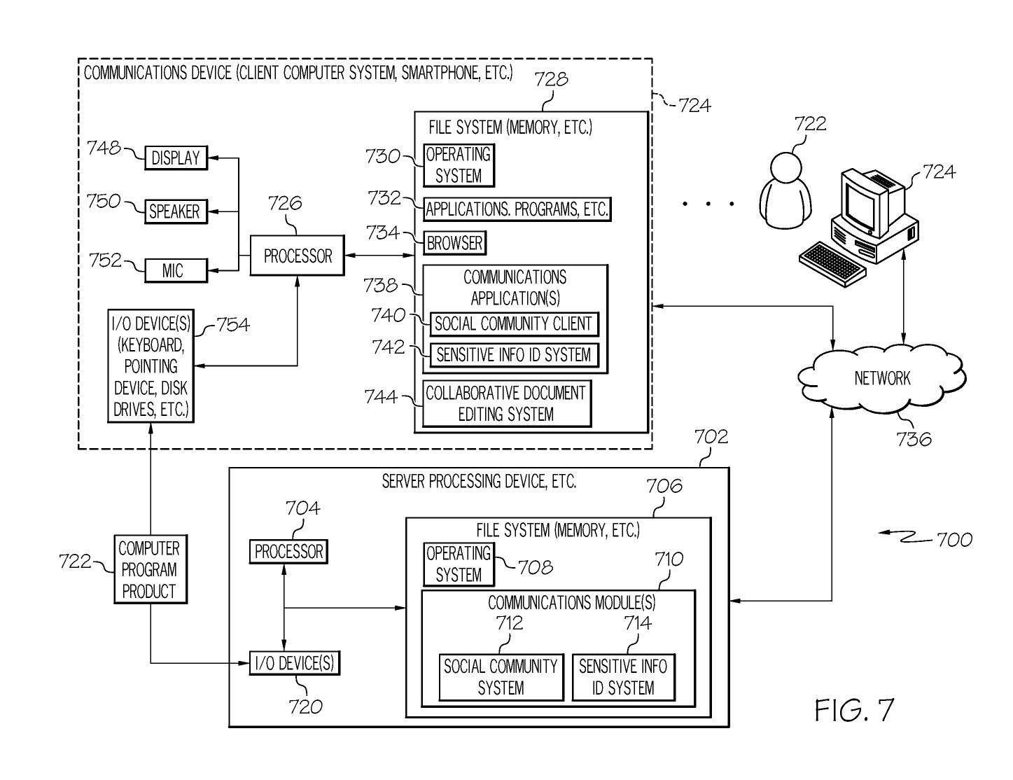

In an embodiment, block 102 defines a first component 134 of a system, such as system 742 in FIG. 7, for identifying sensitive information or confidential information in a communication and blocks 118-132 define a second component 136 for tracking communications and identifying sensitive information or confidential information that is in the process of being communicated to an unauthorized user, wrong user or user that has not previously received the identified sensitive information. The first component 134 and the second component 136 are executed independently. The first component 134 is run to build the relationship graph. The relationship graph may be updated periodically, for example nightly. The second component 136 is executed whenever there is communication or message being written by the user. The system looks up information in the relationship graph built by the first component 134.

In another embodiment, the second component 136 calls the first component 134 dynamically when a communication or message is being written by the user. The first component 134 runs an analysis to create the relationship graph including a list of identified elements (concepts and entities) and relationships to other users or members of a community or different communities based on the elements. A recipient based sensitivity level may then be determined based on the sensitivity level of each of the elements and relationship or connection of each recipient to each element as described herein.

FIG. 2 is a flow chart of an example of a method 200 for determining a sensitivity level of an element, (concept or entity) in accordance with an embodiment of the present invention. In block 202, the sensitivity level of an element may be determined by traversing the same or similar elements for a confidential or sensitive nature of communications or documents containing the same or similar elements. The communications or documents are communications or documents shared between the user and other members within each community. Blocks 204-206 may be features that are performed as part of block 202.

In block 204, elements in communities to which the user or sender of the current communication is a member may be cross-referenced based on a set of elements in the current communication or message.

In block 206, the different communities to which the user or sender is a member may be checked for confidential and/or sensitive elements. Each other community to which the user is a member may be checked for the sensitivity level associated with each element, concept and entity based on tags, document categorization, text statements, restrictions on use, restrictions on access to information or other restrictions or limitations associated with each concept and entity.

FIG. 3 is a flow chart of an example of a method 300 for analyzing a communication for confidential information or sensitive information in accordance with an embodiment of the present invention. In block 302, the communication may be parsed to determine a communication type or if there are any confidentiality tags. In block 304, text of the communication may be parsed for statements that indicate restricted use or sharing limits to specific individuals or groups of individuals.

In block 306, any restrictions or limitations may be correlated to individuals or groups of individuals. Social community metadata on sharing and access may be used to determine confidentiality and sensitivity level of each of the plurality of elements or concepts and entities.

In block 308, a sensitivity level value may be assigned to each concept and entity based on the restrictions or limitations.

FIG. 4 is an example of a relationship graph 400 in accordance with an embodiment of the present invention. The relationship graph 400 may include a plurality of communities 402a, 402b-402m. Members 404a-404n of each community 402a-402m may be shown connected to the respective communities to which the members belong by an arrow or edge 406. A plurality of concepts “C” and a plurality of entities “E” may be associated with each community 402a-402m. The concepts C and entities E may be determined by analyzing the communications between the members of each community 402a-402m similar to that previously described. One or more weights “W” may be associated with each edge 406. Each weight W may represent a relevancy of each element (concept C or entity E) in each community 402a-402m to a particular user or member 404a-404n in each community 402a-402m.

FIG. 5 is an example of a table 500 for determining a recipient based sensitivity level in accordance with an embodiment of the present invention. The table 500 may include a first column of cells 502 containing element (concept or entity) sensitivity level values for each identified element; a second column of cells 504 containing recipient relationship and/or connection to the element values; and a third column of cells 506 containing recipient based sensitivity level values. The recipient based sensitivity values may be a function of the element sensitivity level value in each row and the corresponding recipient relationship/connection to the element value in the corresponding row. For example, in the first row, if the element sensitivity level value is high and the recipient relationship/connection to the element value is no relationship or connection or the value is low, the recipient based sensitivity level will be a high value. The recipient based sensitivity level minimizes or prevents the element (concept or entity) from being sent to or shared with the recipient who may have no relationship or connection to the particular element or the value or degree of the relationship or connection is a low value.

Conversely, in the third row of table 500, if the element sensitivity level in the first column 502 is a high value and the recipient relationship/connection to the element value in the second column 504 is that the recipient has a relationship/connection to the element or the recipient relationship/connection to the element is a high value, the recipient based sensitivity level may be a low value and the corresponding risk of sharing the sensitive element (concept or entity) with the recipient is low because the intended recipient has a relationship or connection to the element. For example, the particular element (concept or entity) was contained in previous communications associated with the intended recipient.

As an example of the present invention using the relationship graph 400 in FIG. 4, user A 404a is a member of community 1 402a, community 2 402b and community M 402m. The first component 134 in FIG. 1A of the method 100 or system analyzes the communications or discussions in each the communities and identifies other users or members of each community involved in the communications or discussions. The first component 134 also identifies elements (concepts and entities) discussed, such as concepts C₁₁, C₁₂. . . C_{1N} and elements E₁₁, E₁₂. . . E_{1N} in community 1 402a. If user A 404a writes a message to user N 404n that mentions element or concept C₁₁, second component 136 of the method 100 or system extracts user N 404n as a person and concept C₁₁ as an element. The second component 136 checks the relationship graph 400 for a relationship between user A 404a and user N 404n that involves concept C₁₁. An alert is provided to user A 404a that the message may be sent to a wrong recipient or unauthorized recipient because there is no relationship between user A 404a and user N 404n that involves concept C₁₁.

FIG. 6 is a block schematic diagram of an example of a social community client 600 in accordance with an embodiment of the present invention. The social community client 600 may be embodied in and operate on a communications device of a user, such as the exemplary communications device 724 in FIG. 7. The methods 100, 200 and 300 may be embodied in and performed by the social community client 600. The methods 100, 200 and 300 may be implemented based on configuration settings 602 on the social community client 600. For example, in block 604, the methods 100, 200 and 300 may be setup as a default behavior so that every time the user operates a “send” command or operation on the communications device, the methods 100, 200 and 300 may execute and report any mismatch or that an element associated with sensitive information is going to be send to a recipient who should not have access to the sensitive information or to a recipient who has not been a participant in previous communications including the sensitive element or information.

In another embodiment or optional configuration setting represented by block 606, the methods 100, 200 and 300 may be enabled or executed in response to the user operating a specific feature, such as a button or other feature for performing functions described herein. Accordingly, the user can control when the methods 100, 200 and 300 are performed or sensitive information identification system is applied on a particular current or outgoing communication.

In another embodiment or optional configuration setting represented by block 608, the configuration settings may be configured to execute the methods 100, 200 and 300 or sensitive information identification system against all recipients or certain groups of recipients, etc. For example, only recipients in the “To” field of a communication are checked to determine the recipient based sensitivity level and whether the level exceeds the risk level threshold as described with respect to the method 100.

The configuration settings 602 may also include other configuration settings 610 that may be selected by the user for operation of the social community client 600 and sensitive information identification system.

FIG. 7 is a block schematic diagram of an example of a system 700 for identifying sensitive information in a communication in accordance with an embodiment of the present invention. The method 100 of FIGS. 1A-1B, method 200 in FIG. 2 and method 300 in FIG. 3 may be embodied in and performed by the system 700 or components of the system 700. The system 700 may include a processing device 702. The processing device 702 may be a server or similar processing device. The processing device 702 may include a processor 704 for controlling operation of the processing device 702 and for performing functions, such as those described herein with respect to identifying sensitive information in a communication. The processing device 702 may also include a file system 706 or memory. An operating system 708, applications and other programs may be stored on the file system 706 for running or operating on the processor 704. A communications module 710 or modules may also be stored on the file system 706. The communications module 710 or modules may be any type of online communications mechanisms for online communications or conversations between users or members of a social network or community. For example, the communications module 710 may include a social community system 712 that may be compiled and run on the processor 704 to perform communications between users or member of different social networks or communities similar to that described herein.

The communications module 710 may also include a sensitive system identification system 714 for identifying sensitive or confidential information in communications similar to that described herein. The methods 100, 200 and 300 or portions of these methods may be embodied in the module 714 for identifying sensitive or confidential information in communications and may be performed by the processor 704 when the sensitive information identification system 714 is compiled and run on the processor 704. The sensitive information identification system 714 may operate in association with the social community system 712 and other types of communications media to perform a set of functions and/or operations associated with the methods 100, 200 and 300. In another embodiment, the system 714 may be a component of the social community system 712 and may operate in association with the social community system 712.

The processing device 702 may also include one or more input devices, output devices or combination input/output devices, collectively I/O devices 720. The I/O devices 720 may include, but are not necessarily limited to, a keyboard or keypad, pointing device, such as a mouse, disk drive and any other devices to permit a user to interface with and control operation of the processing device 702 and to access the social community system 712 and sensitive information identification system 714. At least one of the I/O devices 720 may be a device to read a computer program product, such as computer program product 722. The computer program product 722 may be similar to that described in more detail herein. The communications module 710, social community system 712 and the sensitive information identification system 714 may be loaded on the file system 706 from a computer program product, such as computer program product 722.

A member of a network or social community, or user 722 of the system 700 may use a computer system 724 or communications device to access the processing device 702 or server, communications module 710, social community system 712 and sensitive information identification system 714. The computer system 724 or communications device may be any sort of communications device including a mobile or handheld computer or communications device. The computer system 724 may include a processor 726 to control operation of the computer system 724 and a file system 728, memory or similar data storage device. An operating system 730, applications 732 and other programs may be stored on the file system 728 for running or operating on the processor 726. A web or Internet browser 734 may also be stored on the file system 728 for accessing the processing device 702 or server via a network 736. The network 736 may be the Internet, an intranet or other private or proprietary network.

A communications application 738 or applications for communications between different users or member of a community may also be stored on the file system 728 and operate on the processor 726 of the user's computer system 724.

In accordance with an embodiment, the communications application 738 includes a social community client 740 for communications between the user 722 and other users via the network 736 or between the user 722 and members of different communities to which the user 722 belongs. The social community client may be similar to the social community client 600 in FIG. 6.

The communications application 738 or applications may also include a sensitive information identification system 742. In another embodiment, the sensitive information identification system 742 may be a separate component from the communications application 738 and social community client 740. The methods 100, 200 and 300 or at least portions of the methods 100, 200 and 300, may be embodied in and performed by the sensitive information identification system 742 for identifying sensitive or confidential information similar to that described herein. The sensitive information identification system 742 may perform a set of functions corresponding to methods 100, 200 and 300 or at least portions thereof. In accordance with another embodiment, the sensitive information identification system 742 may be a component of the social community client 740.

The social community client 740 and sensitive information identification system 742 may interface with or operate in conjunction with the social community system 712 and sensitive information identification system 714 on the processing device 702 or server to perform the functions and operations described herein for identifying sensitive or confidential information and alerting the user or sender as described herein. Accordingly, the social community client 740 and sensitive information identification system 742 operating on the computer system 724 may perform some of the functions and operations of the methods 100, 200 and 300 and the social community system 712 and sensitive information identification system 714 on the server 702 may perform other functions of the methods 100, 200 and 300. Some embodiments of the present invention may include only the social community client 740 and sensitive information identification system 714 operating on the processing device 702 or server, and other embodiments may include only the social community client 740 and sensitive information identification system 742 operating on the client computer system 724 or communications device.

A live collaborative document editing system 744 may also be stored on the file system 728 for operation on the processor 726. The live collaborative document editing system 744 may be used in conjunction with or integrated with the social community client 740 and sensitive information identification system 742 for live contextual feedback for redaction options, views and configuration with respect to collaboration on a document by a social community in which the user 722 is a member.

The client computer system 724 may also include a display 748, a speaker system 750, and a microphone 752 for voice communications. One or more user interfaces may be presented on the display 748 for controlling operation of the communications applications 738, social community client 740 and sensitive information identification system 742 for performing the operations and functions described herein.

The computer system 724 may also include one or more input devices, output devices or combination input/output devices, collectively I/O devices 754. The I/O devices 754 may include a keyboard or keypad, pointing device, such as a mouse, disk drives and any other devices to permit a user, such as user 722, to interface with and control operation of the computer system 724 and to access the social community client 740, sensitive information identification system 742 and live collaborative document editing system 744. The I/O devices 754 may also include at least one device configured to read computer code from a computer program product, such as computer program product 722.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for identifying sensitive information in a communication, comprising:
analyzing, by a processor, a plurality of communications associated with a user in a social networking system for concept and entity sharing to create a relationship graph of concept and entity sharing history;
analyzing, by the processor, a current communication from the user to one or more recipients to extract one or more elements from the current communication, each element comprising an associated concept or entity and an associated sensitivity level;
determining, by the processor, a recipient based sensitivity level for each element based on an identity of each recipient and a relationship or connection of each recipient with each element using the relationship graph; and
providing, by the processor, an indication of sending sensitive information to a particular recipient for a particular element in response to the recipient based sensitivity level of the particular element exceeding a configurable risk level threshold.

2. The method of claim 1, wherein analyzing communications associated with the user to create the relationship graph of concept and entity sharing comprises:
extracting a plurality of concepts and a plurality of entities from the communications associated with the user in each community of a plurality of communities to which the user is a member;
identifying other users or members that have access to each community of the plurality of communities; and
identifying concepts and entities and the relationship or connection of the other users or members in each community to each concept and entity.

3. The method of claim 2, further comprising determining the sensitivity level associated with each concept and entity in the relationship graph from at least metadata associated with each concept and entity in the communications associated with the user in the social networking system.

4. The method of claim 3, wherein determining the sensitivity level associated with each concept and entity comprises traversing other communications for confidential or sensitive nature of each concept and entity.

5. The method of claim 4, further comprising cross-referencing each concept and entity in other communities to which the user is a member to determine the sensitivity level associated with each concept and entity.

6. The method of claim 5, further comprising checking each other community to which the user is a member for the sensitivity level associated with each concept and entity based on tags, document categorization, text statements, restrictions on use or restrictions on access to information associated with each concept and entity.

7. The method of claim 1, wherein analyzing the current communication further comprises:
determining an identity of the one or more recipients of the current communication;
extracting each element from the current communication; and
determining the relationship or the connection of each recipient to each extracted element.

8. The method of claim 1, further comprising adjusting the recipient based sensitivity level based on an identity of the recipient and the relationship or connection of the recipient to the element in the relationship graph.

9. The method of claim 1, wherein analyzing communications associated with the user comprises analyzing each communication to determine a confidentiality and sensitivity of each of a plurality of concepts and entities in the communications associated with the user.

10. The method of claim 9, wherein analyzing each communication comprises:
parsing each communication to determine a communication type or confidentiality tags;
parsing text of each communication for statements that indicate restricted use or sharing limits to specific individuals or groups of individuals;
correlating restrictions to individuals;
using social community metadata on sharing and access to determine confidentiality and sensitivity of each of the plurality of concepts and entities; and
assigning a sensitivity level value to each concept and entity based on the restrictions and confidentiality and sensitivity of each of the plurality of concepts and entities.

11. The method of claim 1, further comprising integrating a live collaborative document editing system and the social networking system for live contextual feedback for redaction options, views and configuration.

12. A system for identifying sensitive information in a communication, the system comprising:
a processor;
a module operating on the processor for identifying sensitive information in a communication, the module being configured to cause the processor to perform a set of functions comprising:
analyzing a plurality of communications associated with a user in a social networking system for concept and entity sharing to create a relationship graph of concept and entity sharing history;
analyzing a current communication from the user to one or more recipients to extract one or more elements from the current communication, each element comprising an associated concept or entity and an associated sensitivity level;
determining a recipient based sensitivity level for each element based on an identity of each recipient and a relationship or connection of each recipient with each element using the relationship graph; and
providing an indication of sending sensitive information to a particular recipient for a particular element in response to the recipient based sensitivity level of the particular element exceeding a configurable risk level threshold.

13. The system of claim 12, wherein analyzing communications associated with the user to create the relationship graph of concept and entity sharing comprises:
extracting a plurality of concepts and a plurality of entities from the communications associated with the user in each community of a plurality of communities to which the user is a member;
identifying other users or members that have access to each community of the plurality of communities; and
identifying concepts and entities and the relationship or connection of the other users or members in each community to each concept and entity.

14. The system of claim 13, further comprising determining the sensitivity level associated with each concept and entity in the relationship graph from at least metadata associated with each concept and entity in the communications associated with the user in the social networking system.

15. The system of claim 14, wherein determining the sensitivity level associated with each concept and entity comprises traversing other communications for confidential or sensitive nature of each concept and entity.

16. The system of claim 12, wherein analyzing the current communication further comprises:
determining an identity of the one or more recipients of the current communication;
extracting each element from the current communication; and
determining the relationship or the connection of each extracted element to each recipient.

17. The system of claim 12, further comprising adjusting the recipient based sensitivity level based on an identity of the recipient and the relationship or connection of the recipient to the element in the relationship graph.

18. A computer program product for identifying sensitive information in a communication, the computer program product comprising a computer readable storage medium having program instructions embodied therewith, wherein the computer readable storage medium is not a transitory medium per se, the program instructions being executable by a device to cause the device to perform a method comprising:
analyzing a plurality of communications associated with a user in a social networking system for concept and entity sharing to create a relationship graph of concept and entity sharing history;
analyzing a current communication from the user to one or more recipients to extract one or more elements from the current communication, each element comprising an associated concept or entity and an associated sensitivity level;
determining a recipient based sensitivity level for each element based on an identity of each recipient and a relationship or connection of each recipient with each element using the relationship graph; and
providing an indication of sending sensitive information to a particular recipient for a particular element in response to the recipient based sensitivity level of the particular element exceeding a configurable risk level threshold.

19. The computer program product of claim 18, wherein analyzing communications associated with the user to create the relationship graph of concept and entity sharing comprises:
extracting a plurality of concepts and a plurality of entities from the communications associated with the user in each community of a plurality of communities to which the user is a member;
identifying other users or members that have access to each community of the plurality of communities; and
identifying concepts and entities and the relationship or connection of the other users or members in each community to each concept and entity.

20. The computer program product of claim 18, wherein analyzing the current communication further comprises:
determining an identity of the one or more recipients of the current communication;
extracting each element from the current communication; and
determining the relationship or the connection of each extracted element to each recipient.
